(19) United States
(12) Patent Application Publication
(10) Pub. No.: US 2021/0134541 A1
(43) Pub. Date: May 6, 2021

(54) START BUTTON AND VEHICLE START SWITCH HAVING SAME

(71) Applicants: So Ra LEE, Yongin-si, Gyeonggi-do (KR); HANKOOK MINIMAX CO., LTD., Seoul (KR)

(72) Inventor: So Ra LEE, Yongin-si, Gyeonggi-do (KR)

(73) Assignees: So Ra LEE, Seoul (KR); HANKOOK MINIMAX CO., LTD., Seoul (KR)

(21) Appl. No.: 16/757,204

(22) PCT Filed: Apr. 20, 2018
(86) PCT No.: PCT/KR2018/009542

§ 371 Date: Apr. 17, 2020

(30) Foreign Application Priority Data
Oct. 17, 2017 (KR) 10-2017-0134827

(51) Int. Cl. H01H 13/14; B60K 35/00; H01H 13/04; B60R 16/02

(52) U.S. Cl. CPC H01H 13/14; B60R 16/02; H01H 13/04; B60K 35/00

(57) ABSTRACT

The present invention relates to a start button which is provided on one side of a vehicle to start the vehicle by a pressing operation thereof. the start button includes a case having an opened top surface and provided with an accommodation space therein, a cover member attached to the top surface to shield the opened top surface of the case from the outside and made of a transparent or translucent material to see the accommodation space, and a decorative unit disposed in the accommodation space of the case and constituted by any one of a loge, a letter, a trademark, a picture, and a figure or a combination of two or more thereof, and thus the interior of the vehicle can be upgraded to a high quality by providing the decorative portion on the vehicle start switch and pursuing external beauty.

### TECHNICAL FIELD

The present invention relates to a vehicle start switch, and more particularly, to a vehicle start switch having a start button, on which a decorative unit is provided on the vehicle start switch to purse an elegant outer appearance, thereby upgrading an interior of a vehicle to a high quality.

### BACKGROUND ART

RFID (Radio Frequency Identification) is a technology in which information of the entire process from production to sales are stored in an ultra-small chip (IC chip) to track the information by using a radio frequency and is called an ‘electronic tag’, a ‘smart tag’, an ‘electronic label’, or a ‘wireless identification’.

In recent years, the RFID technology is used as a public transportation toll system, and the scope of its application is being expanded in the future to various fields such as animal tracking devices, automobile safety devices, personal entrance and access permission devices, electronic fee collection devices, and production management as well as distribution fields.

In general, in the RFID card, unique information is input to a tag that is capable of being attached to all objects including people and is read through a reader.

The reading of the information by the RFID card is performed in a non-contact manner. The RFID card that is generally manufactured may set resonance frequencies of a capacitance of a capacitor and an inductance of a coil, which are embedded in the tag or provided outside the tag, to carrier frequencies, thereby allowing the leader to read the information stored in the tag.

However, in the RFID card, since the resonance frequencies are changed due to attenuation in tag inducted voltage of the RFID card by blocking of a magnetic flux and reflection of electromagnetic fields due to a metallic material, the reader may not read the information stored in the tag.

Thus, the designer may change the resonance frequencies in consideration of the attenuation in induced voltage of the tag due to the blocking of the magnetic flux and the reflection of the electromagnetic fields. However, in real life, since the blocking of the magnetic flux, the reflection of the electromagnetic fields, or the influence of other electromagnetic waves are changed from time to time, it may be difficult to read accurate information through the reader.

For example, when a public transportation user uses a transportation card in a state of contacting a cigarette case, a silver foil of a cigarette box may be made of a metallic material to attenuate the induced voltage of the tag due to the blocking of the magnetic flux and the reflection of the electromagnetic fields. As a result, the reader may not recognize the transportation card.

As described above, in the RFID communication according to the related art, when the RFID card is covered by a metal, eddy current generated on a surface of the metal may generate a magnetic flux to interrupt a flow of the alternating magnetic flux. Thus, it may be difficult to read information, or a reading range may be reduced to cause communication disruption and difficulty in smooth use of the communication.

Accordingly, there is a need to develop a vehicle start switch that is capable of being smoothly used without causing the communication disruption when controlling whether the vehicle is started by applying the RFID communication technology to a smart key of the vehicle.

Furthermore, in the case of the vehicle start switch, a start button attached to one side of the inside of the vehicle and installed to be pressed and operated may be most often provided in the shape of a disk simply made of a synthetic resin material. In addition, it is necessary to develop a start button that is capable of enhance the design and consumer sensitivity by pursing an elegant outer appearance of the start button itself to upgrade dignity so as to enhance satisfaction with respect to various demands such as diversification of susceptibility of the vehicle driver due to various shapes and textures of the start switch.

### DISCLOSURE OF THE INVENTION

### Technical Problem

The present invention has been devised to solve the above problems, and thus, an object of the present invention is to provide a vehicle start switch provided with a start button, on which a decorative unit is provided on the vehicle start switch to purse an elegant outer appearance, thereby upgrading an interior of a vehicle to a high quality.

### Technical Solution

A start button for achieving an object of the present invention as described above, which is provided at one side of a vehicle to start the vehicle by a pressing operation thereof, includes: a case having an opened top surface and provided with an accommodation space therein; a cover member attached to the top surface to shield the opened top surface of the case from the outside and made of a transparent or translucent material to see the accommodation space; and a decorative unit disposed in the accommodation space of the case and constituted by any one of a loge, a letter, a trademark, a picture, and a figure or a combination of two or more thereof.

A start button for achieving another object of the present invention as described above, which is provided at one side of a vehicle to start the vehicle by a pressing operation thereof, includes: a case having an opened top surface and provided with an accommodation space therein; a cover member attached to the top surface to shield the opened top surface of the case from the outside and made of a transparent material to see the accommodation space; a decorative unit disposed in the accommodation space of the case and constituted by any one of a loge, a letter, a trademark, a picture, and a figure or a combination of two or more thereof; and a vibrating unit disposed at one side of the case to transmit vibration toward the case.

Here, a separate lighting unit that emits light into the accommodation space so that the decorative unit is recognized through the cover member may be installed at one side of the case.

In addition, the lighting unit may include: a singular or plural LEDs fixedly disposed inside a bottom surface of the case on a peripheral portion of the decorative unit to emit light; and a circuit board on which the LEDs are installed.

In addition, the lighting unit may include: a singular or plural LEDs fixedly disposed outside a bottom surface of the case on a peripheral portion of the decorative unit to emit light; and a circuit board on which the LEDs are installed.

Furthermore, the lighting unit may be interlocked with a door of the vehicle so that light is emitted when the door of the vehicle is opened.

In addition, a top surface of the cover member may be irregularly cut so that the light emitted from the lighting unit is scattered when the light irradiated to the outside.

In addition, a top surface of the cover member may be irregularly cut so that the light emitted from the lighting unit is scattered when the light irradiated to the outside.

Furthermore, a portion of a plate of the circuit board may be cut so that internal configurations are exposed to the outside.

In addition, the vibrating unit may be provided as an actuator interlocked with an operation of an engine of the vehicle so that vibration is generated when the engine of the vehicle is started.

A vehicle start switch provided with a start button for achieving another object of the present invention as described above includes: a start button; a housing disposed around the start button so that the housing is disposed around the start button along an outer circumferential surface of the start button to prevent the start button from moving in a diameter direction of the start button; a magnetic field line generating unit which is provided as a coil, wound around a side surface of the housing to form a magnetic field line, and forms a magnetic flux leakage path between the start button and the magnetic field line generating unit so that the magnetic field line is applied to the outside through the magnetic flux leakage path to recognize a smart key in an RFID manner, thereby starting the vehicle.

Here, a diameter formed by the side surface of the housing around which the coil is wound repeatedly may be equal to or relatively greater than a width of the decorative unit.

In addition, the decorative unit may be disposed at a position within 2 cm in a thickness direction of the housing from the magnetic field line generating unit wound around the side surface of the housing.

In addition, a frequency range used in the RFID manner used may be 125 kHz to 134 kHz.

### Advantageous Effects

As described above, in the vehicle start switch provided with the start button according to the present invention, the decorative unit may be provided on the vehicle start switch to purse the elegant outer appearance, thereby upgrading the interior of the vehicle to the high quality. Therefore, there is the effect of improving the various satisfaction of the consumers on the products.

In addition, the vehicle start switch provided with the start button according to the present invention may have the effect in which, if the high-frequency RFID communication chip embedded in the smart key does not operate due to the discharge of the battery, when the metal key (valet key) embedded in the smart key is taken out to manually open the vehicle door, and then, the user presses the vehicle start button while the smart key contacts the vehicle start button, the magnetic flux is generated from the low-frequency RFID radio communication device (reader) embedded in the vehicle key body, and the reader reads the information of the chip having the long wavelength band (125 kHz to 134 kHz), which is embedded in the smart key, thereby authenticating the security so that the engine is started.

In addition, the vehicle start switch provided with the start button according to the present invention may have the effect of minimizing the operation of the start button to improve the durability of the vehicle engine because the engine of the vehicle and the vibrator are interlocked with each other so that the vibration is generated from the vibrator provided in the vehicle start switch according to whether the vehicle engine is driven so as to clearing recognize the start of the vehicle, thereby preventing the vehicle from unintentionally starting off by the duplicate pressing of the start button.

Furthermore, the vehicle start switch provided with the start button according to the present invention may have the effect of improving the space utilization when the vehicle is designed because the start switch pressed to initially drive the vehicle engine and the reader for performing the security authentication are disposed to be spaced apart from each other.

### BRIEF DESCRIPTION OF THE DRAWINGS

FIG. 1 is an exploded perspective view illustrating a structure of a vehicle start switch provided with a start button according to a first embodiment of the present invention,

FIG. 2 is a view illustrating a state in which magnetic field line is applied through a flux leakage path of the start switch provided with the start button according to the first embodiment of the present invention,

FIG. 3 is a longitudinal cross-sectional view illustrating the structure of the vehicle start switch provided with the start button according to the first embodiment of the present invention,

FIG. 4 is a longitudinal cross-sectional view illustrating a structure of a vehicle start switch provided with a start button according to a second embodiment of the present invention,

FIG. 5 is a longitudinal cross-sectional view illustrating a structure of a vehicle start switch provided with a start button according to a third embodiment of the present invention, and

FIG. 6 is a longitudinal cross-sectional view illustrating a structure of a vehicle start switch provided with a start button according to a fourth embodiment of the present invention.

### MODE FOR CARRYING OUT THE INVENTION

Hereinafter, a vehicle start switch provided with a start button according to embodiments of the present invention will be described with reference to the accompanying drawings.

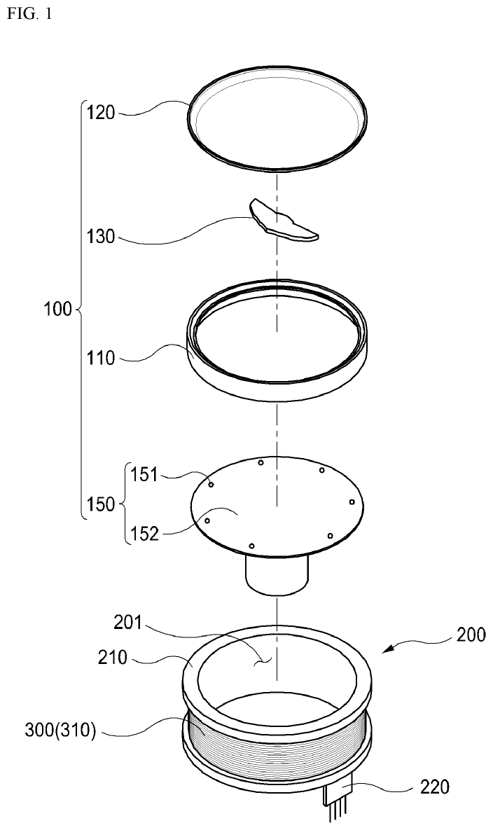

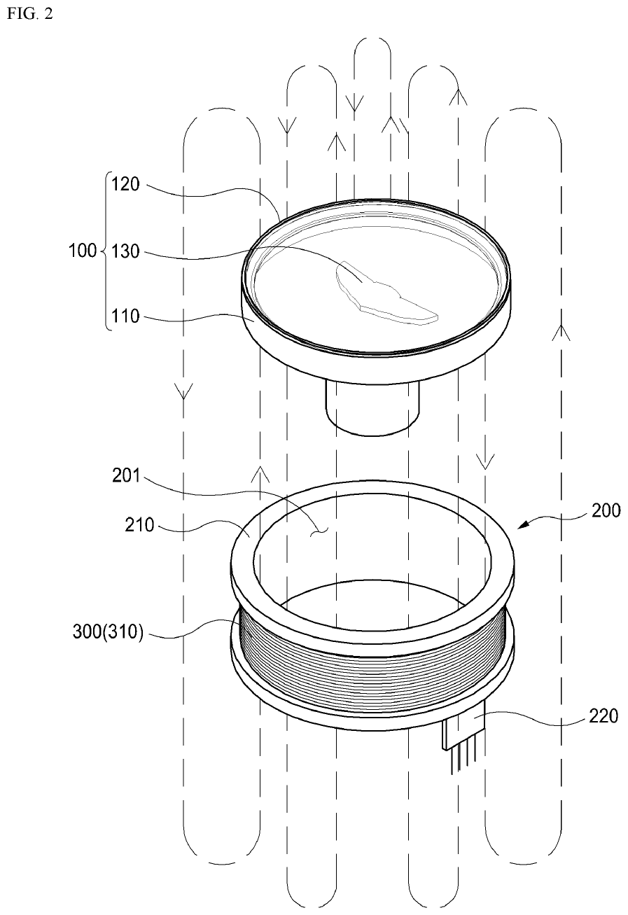

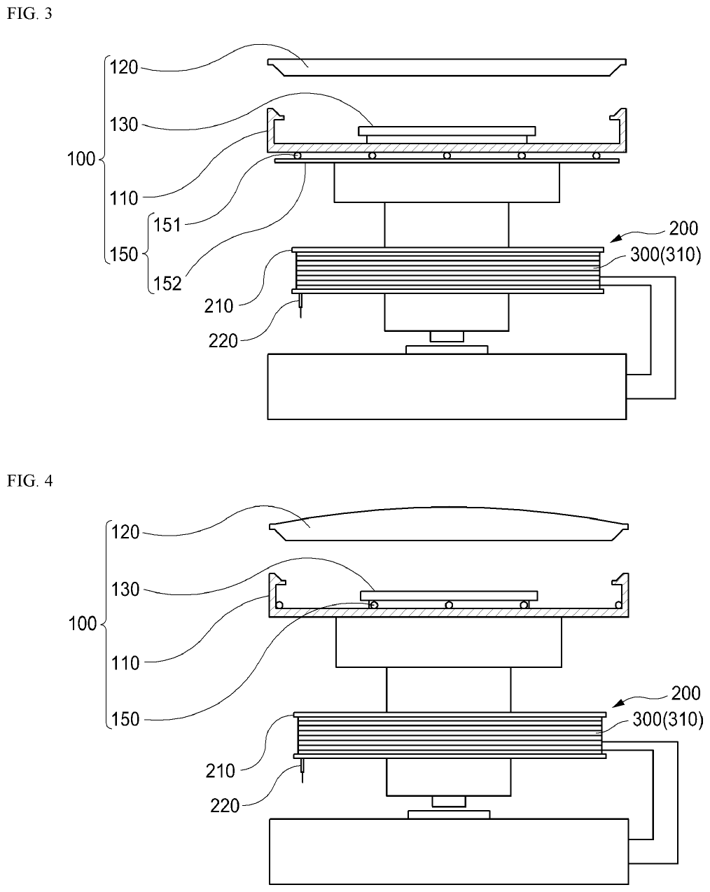

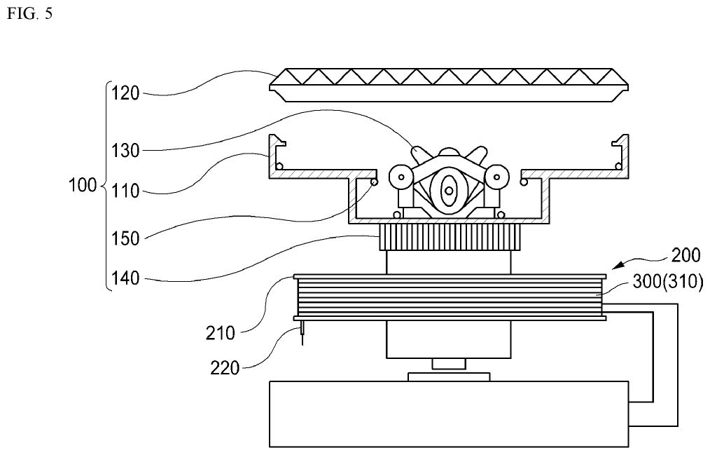

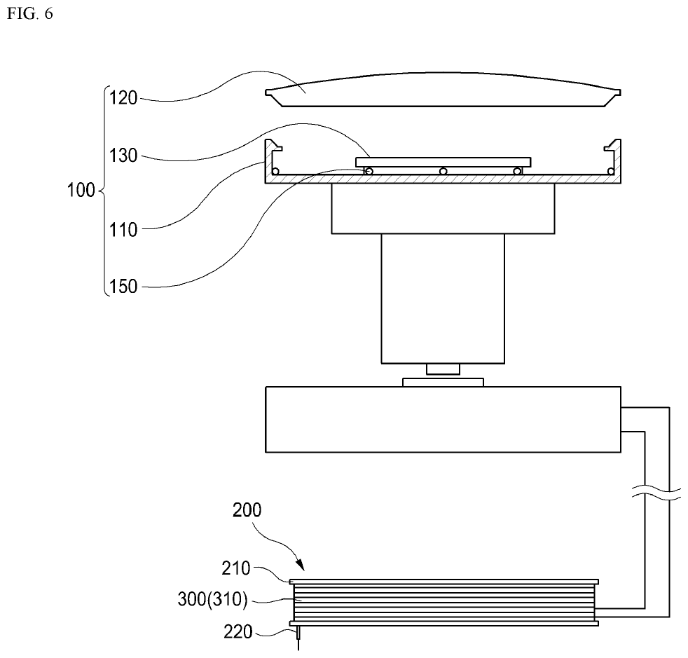

FIG. 1 is an exploded perspective view illustrating a structure of a vehicle start switch provided with a start button according to a first embodiment of the present invention, FIG. 2 is a view illustrating a state in which magnetic field line is applied through a flux leakage path of the start switch provided with the start button according to the first embodiment of the present invention, FIG. 3 is a longitudinal cross-sectional view illustrating the structure of the vehicle start switch provided with the start button according to the first embodiment of the present invention, FIG. 4 is a longitudinal cross-sectional view illustrating a structure of a vehicle start switch provided with a start button according to a second embodiment of the present invention, FIG. 5 is a longitudinal cross-sectional view illustrating a structure of a vehicle start switch provided with a start button according to a third embodiment of the present invention, and FIG. 6 is a longitudinal cross-sectional view illustrating a structure of a vehicle start switch provided with a start button according to a fourth embodiment of the present invention.

As illustrated in the drawings, a start button 100, which is provided at one side of a vehicle to start a vehicle by a pressing operation thereof, according to the present invention includes: a case 110 having an opened top surface and provided with an accommodation space 111 therein; a cover member 120 attached to the top surface to shield the opened top surface of the case 110 from the outside and made of a transparent or translucent material to see the accommodation space 111; a decorative unit 130 disposed in the accommodation space 111 of the case 110 and constituted by any one of a loge, a letter, a trademark, a picture, and a figure or a combination of two or more thereof; and a vibrating unit 140 disposed at one side of the case 110 to transmit vibration toward the case 110.

The case 110 may be a flat cylindrical member having the opened top surface and provided with the predetermined accommodation space 111 therein. The decorative unit 130 may be accommodated in the accommodation space 111, and the cover member 120 made of the transparent or translucent material may be coupled to the top surface of the accommodation space 111 to realize an elegant outer appearance of the start button itself, thereby pursing luxurious start button.

When the decorative unit 130 itself accommodated in the accommodation space 111 is manufactured to be movable, a central region of the case 110 may be formed to be recessed downward at a predetermined depth so that the accommodation space 111 increases in volume.

The cover member 120 may be coupled to the top surface of the case 110 having the opening to protect the decorative unit 130 accommodated in the accommodation space 111 and also be made of the transparent or translucent material so that a vehicle occupant recognizes the decorative unit 130 accommodated in the accommodation space 111 of the case 110, thereby improving satisfaction of the product due to the luxurious product.

Also, a top surface of the cover member 120 may be formed to be convexly curved so that the central region is thicker than an edge thereof, and light emitted from a lighting unit 150, which will be described later, is diffused when the light is irradiated to the outside.

When the central region of the top surface is formed to be thicker than the edge thereof in a state in which a bottom surface of the cover member 120 is formed to be flat, the light emitted from the lighting unit 15 may be diffused to the outside of the cover member 120. Thus, a range that is capable of being recognized by the occupant may be expanded to improve aesthetic satisfaction.

The top surface of the cover member 120 may be irregularly cut so that the light emitted from the lighting unit 150 to be described later is scattered when the light irradiated to the outside.

When the top surface of the cover member 120 is irregularly cut, since the light is scattered while being irradiated to the outside, a front surface of the start button 100 may be twinkled to attract the attention of the occupant, thereby improving the aesthetic satisfaction.

A separate lighting unit 150 that emits light into the accommodation space 111 so that the decorative unit 130 is recognized through the cover member 120 is preferably installed at one side of the case 110.

The lighting unit 150 include a singular or plural LEDs 151 fixedly disposed inside the bottom surface of the case 110 on a peripheral portion of the decorative unit 130 and a circuit board 152 to which the singular or plural LEDs 151 are attached and supported and which is capable of controlling an operation of the LEDs 151.

The lighting unit 150 may be fixedly disposed outside the bottom surface of the case on the peripheral portion of the decorative unit 130. In this case, since the case 110 is made of the transparent material, it is effective to allow the light emitted from the lighting unit 150 to pass through the case 110 so as to be irradiated upward.

Also, in the case of the LEDs 151 constituting the lighting unit 150, each of the LED 151 may have a shape in which a singular or plural spot shapes are provided, or the LED 151 itself may be provided in a ring shape to surround the peripheral portion of the decorative unit 130. Thus, the LED 151 may be modified in various forms.

In addition, the lighting unit 150 may be interlocked with a door of the vehicle to emit light when the door of the vehicle is opened. When the vehicle driver opens the door of the vehicle at night, the lighting unit 150 may emit light to transmit a feeling, which allows the vehicle to greet the driver, to the driver, thereby improving driver's satisfaction.

Furthermore, it is preferable that a portion of a plate of the circuit board 152 constituting the lighting unit 150 is cut so that internal configurations of the lighting unit 150 are exposed to the outside, thereby pursing the luxurious start button 100.

The decorative unit 130 may be provided as a pattern such as a logo, a letter, a trademark, a picture, a figure, or the like. It is preferable to give pride to the driver of the luxury vehicle by forming in combination with marks, symbols, and the like of the companies that manufacture vehicles.

Also, when the door of the vehicle is opened, or the vehicle is started, it is effective to attract the driver's or occupant's eye of the vehicle by giving movement to the decorative unit 130 disposed inside the start button 100.

The vibrating unit 140 may be provided as an actuator interlocked with an operation of the engine of the vehicle so that vibration is generated when the engine of the vehicle is started. When the driver presses the start button 100 to start the vehicle, the vibration may be given to the start button 100 itself to confirm that the vehicle has been properly started through a tactile sense and audibly confirm the vehicle has been properly started through a sound effect.

In the case of a recently developed hybrid vehicle or electric vehicle, even when the engine is driven and started, it is difficult to allow the driver to accurately detect the starting of the engine because there is almost no sound. As a result, the vehicle may be started in duplicate. In this case, if the engine is repeatedly started in duplicate, the engine of the vehicle may be damaged because excessive force is applied to the engine of the vehicle.

However, in the start button 100 according to the present invention, when the vehicle is started, vibration may be generated at the same time in the start button 100 by the vibrating unit 150. As a result, the driver may accurately recognize the starting of the engine of the vehicle to prevent the engine from being started in duplicate, thereby protecting the engine of the vehicle and improving durability of the engine.

The vehicle start switch provided with the start button according to the present invention includes: a start button 100 having the above-described configurations; a housing 200 having a ring-shaped cross-section disposed around the start button 100; and a magnetic field line generating unit which is wound around a side surface of the housing to form a magnetic field line and forms a magnetic flux leakage path between the start button and the magnetic field line generating unit 300 so that the magnetic field line is applied to the outside through the magnetic flux leakage path to recognize the smart key in an RFID manner, thereby starting the vehicle.

Since the start button 100 has the same structure as described above, its detailed description will be omitted.

When the decorative unit 130 provided inside the start button 100 is made of a metal material, there is a problem in that communication is impossible due to radio wave interference in an RFID communication device (reader). However, the present invention may have an advantage that even though each of the smart key and the decorative unit 130 provided in the start button 100 is made of the metal material, the vehicle is capable of being started.

The material of the metal forming the decorative unit 130 may be non-magnetic and non-ferrous metals such as SUB that is an austenite-based (gamma iron hardened by melting carbon elements) metal, titanium, other stainless such as white copper, aluminum, nickel, and the like and also be a material that is plated with a metallic feel.

A separate connector (not shown) inserted into a contact object such as a start console box provided inside the vehicle so that the vehicle is started by a pressing operation and also protruding in a thickness direction of the start button 100 may be provided on one side surface the start button 100 toward the inside of the vehicle.

In addition, when the decorative unit 130 is made of the metal material, it is effective that the decorative unit 130 is disposed at a position within 2 cm in a thickness direction of the housing 200 from the magnetic field line generating unit 300 wound around the side surface of the housing 200.

This is done because even though an alternating magnetic flux crosses the metal due to a change in magnetic fields to generate eddy current on the metal surface and thereby to generate the alternating magnetic flux when the magnetic field line approaches the metal surface, when the decorative unit 130 is disposed within 2 cm from the magnetic field line generating unit 300, the magnetic field line is sufficiently applied to smoothly communicate with the smart key.

The housing 200 is a member through which a hollow 201 passes through a central region thereof and which is formed in a ring shape having a predetermined thickness. Thus, the start button 100 inserted in the hollow 201 may be stably pressed without moving.

A ring-shaped hook protrusion 210 that prevents the magnetic field line generating unit 300 wound around the side surface of the housing 200 from being separated is preferably formed on a circumferential surface of each of both ends of the housing 200.

Also, it is effective that a separate connector (220) is disposed at one side of the housing 200 to protrude in the thickness direction of the housing 200 so as to be electrically connected to the magnetic field line generating unit 300 wound around the side surface of the housing 200 to supply power to the magnetic field line generating unit 300.

Also, it is preferable that a diameter formed by the side surface of the housing 200 around which a coil 310 is wound is equal to or relatively greater than a width of the decorative unit 130 when the decorative unit 130 is made of the metal material.

This is done for a reason in which the magnetic field line formed by the magnetic field line generating unit 300 is formed outside the decorative unit 130 to smoothly apply the magnetic field line to the outside through the magnetic flux leakage path formed between the decorative unit 130 and the housing 200 so as to smoothly communicate with the smart key.

The magnetic field line generating unit 300 may be provided in the form of the thin coil 310 having a predetermined length. Thus, as the magnetic field line generating unit 300 is repeatedly wound around the side surface of the housing 200 between the hook protrusions 210, as illustrated in FIG. 2, when power is applied, the magnetic field line may be formed in a longitudinal direction along the thickness direction of the housing 200 by a magnetic induction phenomenon.

Since the number of times of winding the magnetic field line generating unit 300 having the form of the thin coil 310 around the side surface of the housing 200 is adjusted to control intensity of the magnetic field line generated in the magnetic field line generating unit 300, the number of times of winding the coil 310 around the side surface of the housing 200 may be variously changed according to characteristics of the vehicle.

Also, as illustrated in FIG. 6, the housing 200 around which the magnetic field line generating unit 300 provided as the coil 310 is wound may be provided on one side within the vehicle at a position that is spaced a predetermined distance from a set position at which the start button 100 is installed. Thus, even when the decorative unit 130 is made of the metal material, the housing 200 may not be affected by the decorative unit 130 but smoothly communicate with the smart key.

In the case of this configuration, the housing 200 may be disposed at a different position within the vehicle to reduce the overall volume of the vehicle start switch that is generally provided at one side of a center fascia of the vehicle. As a result, when the center fascia is designed, a degree of freedom in design may be improved to increase in space utilization.

Although not shown, when the communication between the magnetic field line generating unit 300 and the smart key is interrupted due to the decorative unit 130 made of the metal material, it is effective that an amorphous alloy sheet is disposed between the start button 100 and the magnetic field line generating unit 300.

In addition, a separate side cover (not shown) having a ring shape to support the amorphous alloy sheet may be provided in front of the housing 200. Thus, when the amorphous alloy sheet is disposed, the amorphous alloy sheet may be firmly supported.

When the amorphous alloy sheet is installed, there is an effect that a distance of the magnetic flux flow of the magnetic field line formed by the magnetic field line generating unit 300 increases to more smoothly communicate with the smart key.

The vehicle may have a smart key based on wireless communication and an emergency metal key embedded in the smart key. Here, in the smart key, a communication manner with both RFID chips having two wavelength bands, i.e., a long wavelength (125 kHz to 134 kHz) band for short-range radio transmission and short wavelength (433 MHz) band for long-distance radio transmission is used in combination.

A high frequency radio refers to wireless communication that operates the opening and closing of the door of the vehicle and operates trunk starting from a long distance, and a low frequency radio is mainly used for emergency purposes in the vehicle.

Thus, the frequency range used in the RFID communication used in the present invention may have a low-frequency (LF) long wavelength band of 125 kHz to 134 kHz. The vehicle start switch provided with the start button according to the present invention may be formed so that electric fields and magnetic lines, which are AC-changed from the current flow direction when the current is applied, are formed to have a phase of 90 degrees, and the magnetic field line may be applied to the outside through the magnetic flux leakage path to communicate with the smart key.

An operation process of the vehicle start switch provided with the start button having the above-described configuration according to the present invention will be described in more detail as follows.

In general, the vehicle may have a smart key based on wireless communication and an emergency metal key embedded in the smart key. Here, in the smart key, a communication manner with both RFID chips having two wavelength bands, i.e., a long wavelength (125 kHz to 134 kHz) band for short-range radio transmission and short wavelength (433 MHz) band for long-distance radio transmission is used in combination.

A chip (passive type/having a long wavelength of 125 kHz to 134 kHz) having a long wavelength band, which is mounted inside the smart key, may start the vehicle by using the start button 100 through encoded communication with the vehicle start switch provided with the start button according to the present invention.

In the communication method between the smart key and the vehicle start switch provided with the start button, when the current is applied to the coil 310 constituting the magnetic field line generating unit 300, the magnetic field line is generated in the peripheral portion of the housing 200, around which the coil is wound, by the magnetic induction phenomenon.

In addition, the magnetic field line is applied to the outside of the vehicle start switch through the magnetic flux leakage path formed between the start button 100 and the housing 200, and the encoded communication between the vehicle start switch and the smart key is achieved by the magnetic field line to recognize the smart key, thereby starting the vehicle.

Although the above description merely corresponds to some exemplary embodiments that may be implemented by the present invention, as well known, the scope of the present invention should not be interpreted as being limited to the above-described embodiments, and all technical spirits having the same basis as that of the above-described technical spirit of the present invention are included in the scope of the present invention.

### INDUSTRIAL APPLICABILITY

The present invention may be used in the motor and automobile technology fields and mechanical technology fields in which the starting is performed using the button.

1. A start button which is provided at one side of a vehicle to start the vehicle by a pressing operation thereof, the start button comprising:
a case (100) having an opened top surface and provided with an accommodation space (111) therein;
a cover member (120) attached to the top surface to shield the opened top surface of the case (110) from the outside and made of a transparent or translucent material to see the accommodation space (111); and
a decorative unit (130) disposed in the accommodation space (111) of the case (110) and constituted by any one of a loge, a letter, a trademark, a picture, and a figure or a combination of two or more thereof.

2. The start button of claim 1, comprising:
a vibrating unit (140) disposed at one side of the case (110) to transmit vibration toward the case (110).

3. The start button of claim 1, wherein a separate lighting unit (150) that emits light into the accommodation space (111) so that the decorative unit (130) is recognized through the cover member (120) is installed at one side of the case (110).

4. The start button of claim 3, wherein the lighting unit (150) comprises:
a singular or plural LEDs (151) fixedly disposed inside a bottom surface of the case (110) on a peripheral portion of the decorative unit (130) to emit light; and
a circuit board (152) on which the LEDs (151) are installed.

5. The start button of claim 3, wherein the lighting unit (150) comprises:
a singular or plural LEDs (151) fixedly disposed outside a bottom surface of the case (110) on a peripheral portion of the decorative unit (130) to emit light; and
a circuit board (152) on which the LEDs (151) are installed.

6. The start button of claim 3, wherein the lighting unit (150) is interlocked with a door of the vehicle so that light is emitted when the door of the vehicle is opened.

7. The start button of claim 6, wherein a top surface of the cover member (120) is formed to be convexly curved so that the central region is thicker than an edge thereof, and light emitted from a lighting unit (150), which will be described later, is diffused when the light is irradiated to the outside.

8. The start button of claim 6, wherein a top surface of the cover member (120) is irregularly cut so that the light emitted from the lighting unit (150) is scattered when the light irradiated to the outside.

9. The start button of claim 4, wherein a portion of a plate of the circuit board (152) is cut so that internal configurations are exposed to the outside.

10. The start button of claim 2, wherein the vibrating unit (140) is provided as an actuator interlocked with an operation of an engine of the vehicle so that vibration is generated when the engine of the vehicle is started.

11. The start button of claim 2, wherein the vibrating unit (140) is interlocked with the operation of the engine of the vehicle so that a sound is generated when the engine of the vehicle is started.

12. A vehicle start switch provided with a start button, comprising:
a start button (100) of claim 1;
a housing (200) disposed around the start button (100) so that the housing (200) is disposed around the start button (100) along an outer circumferential surface of the start button (100) to prevent the start button (100) from moving in a diameter direction of the start button (100);
a magnetic field line generating unit (300) which is provided as a coil (310), wound around a side surface of the housing (200) to form a magnetic field line, and forms a magnetic flux leakage path between the start button (100) and the magnetic field line generating unit (300) so that the magnetic field line is applied to the outside through the magnetic flux leakage path to recognize a smart key in an RFID manner, thereby starting the vehicle.

13. The vehicle start switch of claim 12, wherein a diameter formed by the side surface of the housing (200) around which the coil (310) is wound repeatedly is equal to or relatively greater than a width of the decorative unit (130).

14. The vehicle start switch of claim 13, wherein the decorative unit (130) is disposed at a position within 2 cm in a thickness direction of the housing (200) from the magnetic field line generating unit (300) wound around the side surface of the housing (200).

15. The vehicle start switch of claim 12, wherein a frequency range used in the RFID manner used is 125 kHz to 134 kHz.

16. A vehicle start switch provided with a start button, comprising:
a start button (100) of claim 1;
a housing (200) provided on one side within the vehicle at a position spaced a predetermined distance from a position at which the start button (100) is installed; and
a magnetic field line generating unit (300) which is wound around a side surface of the housing (200) to form a magnetic field line, forms a magnetic flux leakage path through which the magnetic field line leaks to the outside so that the magnetic field line is applied to the outside through the magnetic flux leakage path to recognize a smart key in an RFID manner, thereby starting the vehicle.
